(19) United States
(12) Patent Application Publication
(10) Pub. No.: US 2024/0230899 A9
(43) Pub. Date: Jul. 11, 2024

(54) DISTANCE MEASUREMENT DEVICE AND DISTANCE MEASUREMENT METHOD

(71) Applicant: DENSO CORPORATION, Kariya-city (JP)

(72) Inventor: TOMONARI YOSHIDA, Kariya-city (JP)

(21) Appl. No.: 18/405,592

(22) Filed: Jan. 5, 2024

Related U.S. Application Data
(63) Continuation of application No. PCT/JP2022/023314, filed on Jun. 9, 2022.

(30) Foreign Application Priority Data
Jul. 9, 2021 (JP) 2021-114259

(51) Int. Cl. G01S 17/10; G01S 7/48; G01S 7/484; G01S 7/4863; G01S 7/487

(52) U.S. Cl. CPC G01S 17/10; G01S 7/4808; G01S 7/484; G01S 7/4863; G01S 7/4873

(57) ABSTRACT

A distance measurement device is for irradiating a target region with light and measuring a distance to a target object present in the target region. The distance measurement device includes a light emission controller, a detection information acquirer, and a distance calculator. The light emission controller controls a light emitting unit, which emits light toward the target region. The detection information acquirer acquires detection information obtained by a light receiving unit, which detects light from the target region. The distance calculator calculates a distance to the target object using the detection information. The light emission controller controls the light emitting unit to emit light pulses respectively having different light emission intensities for different light emission periods per unit measurement time. The distance calculator calculates the distance using detection timings of response pulses respectively generated by the light pulses being reflected from the target object.

### CROSS REFERENCE TO RELATED APPLICATIONS

The present application is a continuation application of International Patent Application No. PCT/JP2022/023314 filed on Jun. 9, 2022, which designated the U.S. and claims the benefit of priority from Japanese Patent Application No. 2021-114259 filed on Jul. 9, 2021. The entire disclosures of all of the above applications are incorporated herein by reference.

### TECHNICAL FIELD

The present disclosure relates to a distance measurement device and a distance measurement method for measuring a distance to a target object.

### BACKGROUND

Conventional distance measurement devices use light pulses and measure a distance to a target object based on a time of flight (TOF) of the light pulses.

### SUMMARY

According to at least one embodiment, a distance measurement device is for irradiating a target region with light and measuring a distance to a target object present in the target region. The distance measurement device includes a light emission controller, a detection information acquirer, and a distance calculator. The light emission controller controls a light emitting unit, which emits light toward the target region. The detection information acquirer acquires detection information obtained by a light receiving unit, which detects light from the target region. The distance calculator calculates a distance to the target object using the detection information. The light emission controller controls the light emitting unit to emit light pulses respectively having different light emission intensities for different light emission periods per unit measurement time. The distance calculator calculates the distance using detection timings of response pulses respectively generated by the light pulses being reflected from the target object.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a distance measurement device according to a first embodiment.

FIG. 2 is a diagram illustrating functional blocks of a signal processing device.

FIG. 3 is a diagram illustrating outgoing light according to the first embodiment.

FIG. 4 is a diagram illustrating a light emission sequence.

FIG. 5 is a diagram illustrating a response pulse.

FIG. 6 is a diagram illustrating a saturated response pulse.

FIG. 7 is a diagram illustrating another example of a response pulse.

FIG. 8 is a flowchart illustrating a process of the signal processing device.

FIG. 9 is a diagram illustrating a multipath detection process.

FIG. 10 is a diagram illustrating a measuring range.

FIG. 11 is a diagram illustrating multiple reflection.

FIG. 12 is a diagram illustrating a detection process of the multiple reflection.

FIG. 13 is a diagram illustrating another example of a light emission sequence.

FIG. 14 is a diagram illustrating a light emission sequence for each pixel.

FIG. 15 is a diagram illustrating a light emission sequence for each frame.

FIG. 16 is a diagram illustrating another example of a light emission sequence for each pixel.

FIG. 17 is a diagram illustrating still another example of a light emission sequence for each pixel.

### DETAILED DESCRIPTION

To begin with, examples of relevant techniques will be described.

A distance measurement device according to a comparative example uses light pulses and measures a distance to a target object based on a time of flight (TOF) of the light pulses. More specifically, since a part of light emitted from a light source of the distance measurement device is reflected by a target object and returns to a detector of the distance measurement device, a distance from the distance measurement device to the target object is estimated based on a time from the emission of a light pulse to detection by the detector.

In the distance measurement device described above, for example, if the target object is at a short distance, or if the target object is a high-luminance reflective object, light intensity of the reflected light pulse may be too large to exceed a detection range of a light receiving element in the detector. If the intensity of the reflected light pulse exceeds the detection range of the light receiving element, a position of a peak of the reflected light pulse is not known, and thus measurement accuracy of the distance may decrease.

In contrast to the comparative example, according to a distance measurement device and a distance measurement method of the present disclosure, measurement accuracy can be improved.

According to an aspect of the present disclosure, a distance measurement device is for irradiating a target region with light and measuring a distance to a target object present in the target region. The distance measurement device includes a light emission controller, a detection information acquirer, and a distance calculator. The light emission controller controls a light emitting unit, which emits light toward the target region. The detection information acquirer acquires detection information obtained by a light receiving unit, which detects light from the target region. The distance calculator calculates a distance to the target object using the detection information. The light emission controller controls the light emitting unit to emit light pulses respectively having different light emission intensities for different light emission periods per unit measurement time. The distance calculator calculates the distance using detection timings of response pulses respectively generated by the light pulses being reflected from the target object.

According to the distance measurement device, since the light pulse has different light emission intensities per unit measurement time, the response pulses can be obtained by the light receiving unit when there is reflection from the target object. Therefore, the distance can be calculated using the detection timings of the response pulses included in the detection information. For example, even when the detection timing of one response pulse is unclear due to saturation, noise, or the like, if the detection timing of another response pulse is clear, the distance can be measured using another response pulse. Accordingly, the distance measurement device and the distance measurement method with excellent measurement accuracy can be realized.

### First Embodiment

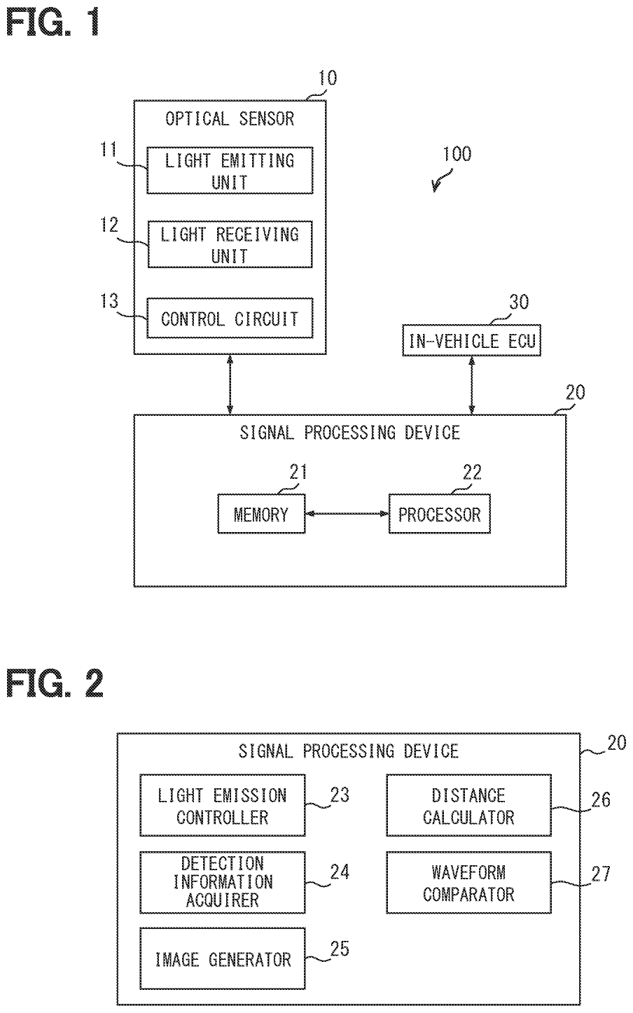

Hereinafter, a first embodiment of the present disclosure will be described with reference to FIGS. 1 to 17. A distance measurement device 100 of the present embodiment emits light toward a target region and measures a distance to a target object 101 present in the target region. As shown in FIG. 1, the distance measurement device 100 includes an optical sensor 10 and a signal processing device 20. The distance measurement device 100 of the present embodiment is mounted on a vehicle and measures the distance to a target object 101 around the vehicle.

The distance measurement device 100 is also referred to as a LiDAR. The LiDAR stands for Light Detection and Ranging/Laser Imaging Detection and Ranging. The distance measurement device 100 measures a distance to a reflection point by detecting light reflected from the reflection point in response to irradiation of light to the reflection point. The distance measurement device 100 is, for example, a sensor mounted on a vehicle having at least one of an advanced driving assistance function or an automated driving function. The distance measurement device 100 is communicably connected to an in-vehicle electronic control unit (i.e., ECU) 30 through an in-vehicle local area network (i.e., LAN). The in-vehicle ECU 30 is an electronic control device that uses measurement result of the distance measurement device 100 for processing such as advanced driving assistance and automated driving.

The optical sensor 10 performs irradiation of light and detection of reflected light. The optical sensor 10 measures a flight time of light (Time of Flight) by measuring a time difference between a time when light is emitted from a light source and a time when the reflected light arrives. The optical sensor 10 includes a light emitting unit 11, a light receiving unit 12, and a control circuit 13.

The light emitting unit 11 emits light toward a target region. The light emitting unit 11 is a light source that emits laser light toward an outside of the vehicle, and is, for example, a laser element. The light emitting unit 11 emits laser light in a form of an intermittent pulse beam under the control of the control circuit 13. The light emitting unit 11 causes a movable optical member to scan the laser light in accordance with the emitting timing of the laser light.

The light receiving unit 12 detects light from the target region. The light receiving unit 12 detects light from a periphery of the vehicle, and includes light receiving elements. One of the light receiving elements is an imaging element that detects light including reflected light from the target object 101 in response to laser light irradiation by the light emitting unit 11. The target object 101 is, for example, other vehicles and a feature or a ground object around the vehicle. Hereinafter, the reflected light from the target object 101 with respect to the laser light irradiation is simply referred to as “reflected light”.

For example, sensitivity of the light receiving element to a vicinity of a wavelength of the laser light emitted by the light emitting unit 11 is set to be high. The light receiving elements are arranged in an array in a one-dimensional direction or a two-dimensional direction. The number of light receiving elements corresponds to the number of pixels. For example, the light receiving element is a single photon avalanche photodiode (i.e., SPAD). The SPAD generates one electric pulse by an electron multiplication operation by avalanche multiplication when one or more photons are incident. The SPAD outputs an electric pulse which is a digital signal without passing through an AD conversion circuit.

The control circuit 13 executes an irradiation function of scanning laser light and a reflected light detection function of detecting reflected light. In the irradiation function, the control circuit 13 controls irradiation and scanning of the laser light of the light emitting unit 11. In the reflected light detection function, the control circuit 13 reads the electric pulse output by the light receiving elements of the light receiving unit 12.

More specifically, the control circuit 13 sequentially exposes and scans each of scanning lines of the light receiving elements in accordance with the irradiation of the laser light. As a result, the control circuit 13 acquires the number of electric pulses at each time point within an exposure time output from each light receiving element as detection data. Then, the control circuit 13 generates detection information in which an elapsed time from an irradiation time point of the laser light and a detection time point of each detection signal within the exposure time indicated by the detection data are associated with each other. The control circuit 13 outputs the generated detection information to the signal processing device 20.

The signal processing device 20 generates a point cloud image of the target object 101 based on the detection information from the optical sensor 10. The signal processing device 20 is a controller, and is a computer including at least one memory 21 and one processor 22 as shown in FIG. 1. The memory 21 is a non-transitory tangible storage medium that non-transiently stores computer-readable programs, data, and the like. The memory 21 includes at least one type of non-transitory tangible storage medium such as a semiconductor memory, a magnetic medium, and an optical medium. The memory 21 stores various programs executed by the processor 22, such as a ranging control program and an image processing program described later.

The processor 22 includes, for example, at least one of a central processing unit (CPU), a graphics processing unit (GPU), a reduced instruction set computer (RISC)-CPU, and the like as a core. The processor 22 executes, for example, instructions included in a distance measurement program stored in the memory 21. The signal processing device 20 realizes a distance measurement method for measuring a distance to the target object 101 present in the target region by executing the distance measurement program. The signal processing device 20 executes the image processing program to execute image processing for generating the point cloud image of the target object 101 from the detection result of the optical sensor 10. The signal processing device 20 constructs multiple functional units by causing the processor 22 to execute the multiple instructions. More specifically, as shown in FIG. 2, the signal processing device 20 includes a light emission controller 23, a distance calculator 26, a detection information acquirer 24, a waveform comparator 27, and an image generator 25 as functional units.

The light emission controller 23 controls the light emitting unit 11. The light emission controller 23 gives an operation command to the optical sensor 10. The control circuit 13 controls the light emitting unit 11 based on the operation command. The light emission controller 23 controls the number of light pulses, a waveform shape, and light emission intensity per unit measurement time in which the light emitting unit 11 emits light. The light pulse emitted by the light emitting unit 11 will be described later.

The detection information acquirer 24 acquires the detection information obtained by the light receiving unit 12. The detection information acquirer 24 determines whether waveform information of the detected reflected wave is valid based on the newly acquired detection information. For example, the detection information acquirer 24 determines whether the waveform information is valid based on a magnitude of the S/N ratio of a waveform and an amplitude of the waveform. When it is determined that the waveform information is not valid, the detection information acquirer 24 rejects the acquired detection information. The detection information acquirer 24 acquires detection information for all pixels in each control cycle. The detection information acquirer 24 sequentially provides the acquired detection information to the distance calculator 26.

The distance calculator 26 calculates a distance to the target object 101 using the detection information. The distance calculator 26 calculates a distance by using detection timings of response pulses generated by reflection of a light pulse on the target object 101. More specifically, the distance calculator 26 calculates a distance to a reflection point on the target object 101. The reflection point is a point reflected on the target object 101 relative to the laser light irradiation. The reflection point can also be referred to as an emission point of the reflected light. The distance calculator 26 sequentially provides a calculated distance value to the reflection point to the image generator 25.

The image generator 25 converts the distance value to the reflection point calculated by the distance calculator 26 into three-dimensional coordinate information. The image generator 25 converts the distance value into a three-dimensional coordinate value based on a focal length of an optical system, the number of light receiving elements, the size of the light receiving elements, and the like. The three-dimensional coordinate value is a coordinate system centered on the distance measurement device 100. The image generator 25 converts all distance values into three-dimensional coordinate values of the three-dimensional coordinate system, and generates a point cloud image including coordinate information of the reflection point corresponding to each light receiving element.

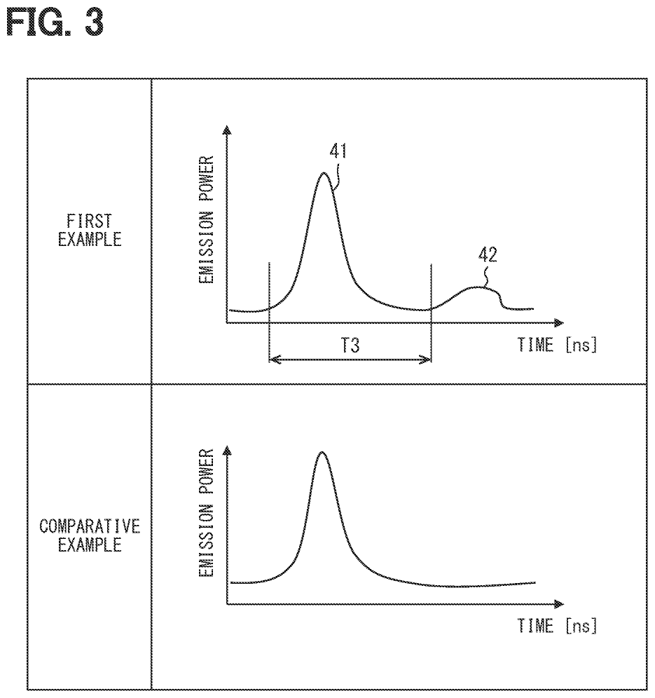

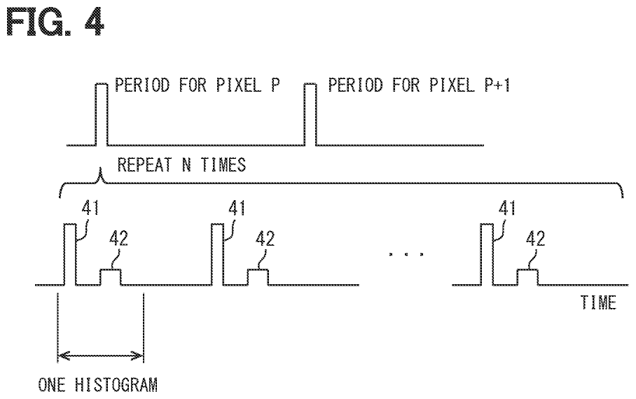

Next, a light pulse emitted by the light emitting unit 11 will be described with reference to FIGS. 3 and 4. As shown in a first example of FIG. 3, outgoing light is characterized in that the emitted light has light pulses, or two light pulses in the present embodiment, respectively having different light emission intensities per unit measurement time and different light emission periods. The unit measurement time is a generation time of one histogram. The unit measurement time is a time set for receiving the reflected light after the light is emitted. The unit measurement time is set based on, for example, a distance measurement upper limit. In the first example, light emission intensity of a light pulse in a first part is higher than light emission intensity of a light pulse in a second part. In addition, the light emission period of the light pulse in the first part and the light emission period of the light pulse in the second part do not overlap each other and are temporally shifted from each other. Hereinafter, the light pulse of the first part may be referred to as a first emission pulse 41, and the light pulse of the second part may be referred to as a second emission pulse 42. The first example is also characterized in that the first emission pulse 41 and the second emission pulse 42 have different emission waveforms. The second emission pulse 42 has a flatter shape than the first emission pulse 41 and is asymmetrical in a left-right direction. Contrary to this, in a comparative example, there is only one light pulse per unit measurement time.

As shown in FIG. 4, the light emission period is assigned to each pixel. Then, light emission is controlled so as to have the same light emission pattern in all the pixels. The light emission pattern is a combination of the number of light pulses per unit measurement time, the light emission intensity of the light pulses, and the waveform shape of the light pulses. Therefore, for example, in a period for a certain first pixel p and a period for another second pixel p+1, the light emission patterns are controlled to be the same. As described above, two light pulses are provided within the generation time of one histogram, and the light emission is performed a plurality of times, for example, N times.

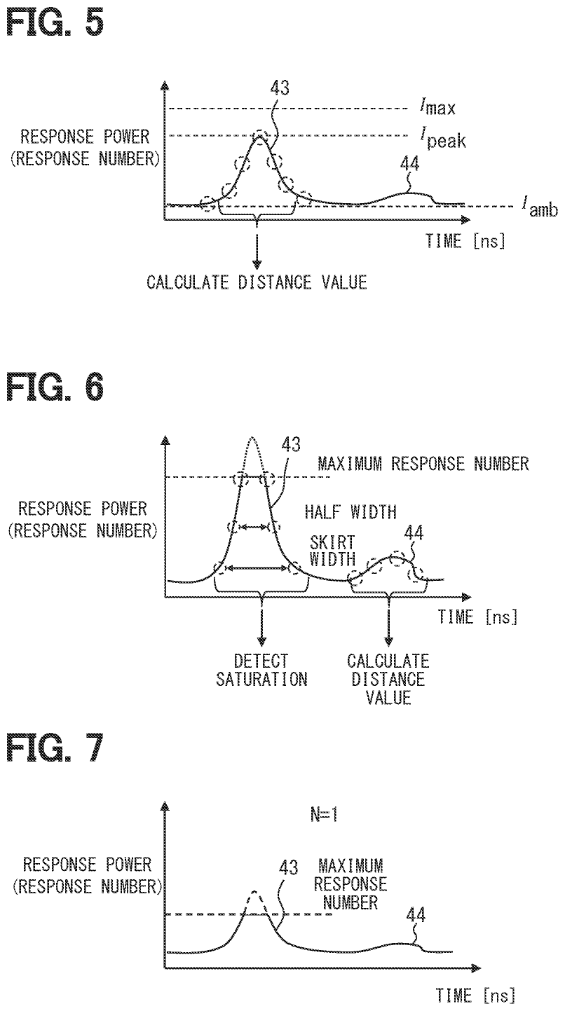

Next, a response pulse of the reflected light will be described with reference to FIGS. 5 to 7. Since the outgoing light has two light pulses as described above, under ideal conditions, the reflected light also has two response pulses as shown in FIG. 5. Hereinafter, a response pulse of a first part may be referred to as a first response pulse 43, and a response pulse of a second part may be referred to as a second response pulse 44.

In FIGS. 5 to 7, a vertical axis represents response power. The response power corresponds to the light intensity. In the present embodiment, since the light receiving element is the SPAD, the response power corresponds to the number of responses. The light receiving unit 12 has a structure in which SPADs, which output one large electric pulse signal by multiplication like an avalanche, are arranged for each pixel when 1 or more photons, which are particles of light, are incident on the pixel. Since the SPAD can be multiplied from one photon to many electrons, the light receiving unit 12 is capable of detecting from one photon, and the number of output electric pulse signals is the number of responses.

When detecting the distance, it is desirable to use the detection time point of a peak value of each response pulse. This is because the distance can be calculated with high accuracy by the time difference between the peak value of each light pulse of the outgoing light and the peak value of each response pulse. As shown in FIG. 4, the peak value is obtained by sampling. The control circuit 13 counts the number of electric pulses output from each light receiving element in each sampling. Then, the control circuit 13 generates a histogram in which the number of electric pulses for each sampling is recorded. Each class of the histogram indicates a time of flight (Time of Flight, TOF) of light, which is an elapsed time for each sampling from an emission time point of the light emitting unit 11. Therefore, sampling frequency corresponds to time resolution of TOF measurement.

When the peak value can be detected by the sampling, the distance is calculated using the peak value as shown in FIG. 5. As shown in FIG. 6, since the first response pulse 43 is saturated and the peak value cannot be detected with high accuracy, the distance is calculated using the peak value of the second response pulse 44.

The saturation shown in FIG. 6 means an upper limit value related to the light receiving intensity of each light receiving element. When each light receiving element is a SPAD, the received light intensity corresponding to the number of responses of the SPAD in each light receiving element is acquired. If the distance is calculated by the saturated first response pulse 43, the distance is calculated by regarding the sampling time point at the time of the maximum number of responses as the peak value, for example.

FIG. 7 shows an example of a response pulse in a case where the outgoing light has two light pulses within the generation time of one histogram and the light emission is performed N=1 time. In a case of N=1, the maximum number of responses to be saturated is smaller than that in a case of FIG. 6. Even in the case of N=1, a peak value or saturation occurs in the response power, and thus the distance can be calculated even in the case of N=1.

Next, a method of determining saturation will be described. Whether saturation occurs can be determined using a sampling value. For example, when (1) there is a predetermined K1 or more maximum number of responses, when (2) there is a predetermined K2 or more maximum number of responses and the half width is a predetermined T1 [ns] or more, and when (3) there is a K3 or more maximum number of responses and a skirt width is a predetermined T2 [ns] or more, it is determined to be saturated. The determination conditions (1) to (3) may be used individually or may be used in combination. The values of Kl, K2, and K3 may be different from each other or may be the same. The values of T1 and T2 may also be different or the same. These values are determined, for example, by prior experiments and simulations.

Further, in order to determine whether the response pulse of the reflected light has an appropriate waveform with less noise, the distance calculator 26 calculates the signal-to-noise ratio (S/N ratio) of the first response pulse 43 and the second response pulse 44. When the calculated signal-to-noise ratio (hereinafter, it may be simply referred to as S/N ratio) satisfies a predetermined condition, the waveform is determined to be an appropriate waveform with less noise. As the S/N ratio increases, it can be determined that there is less noise. The S/N ratio can be calculated by the following equations (1) to (4).

$$\\ \begin{matrix}[ Math 1 ] & \\ SN = \frac{{I}_{peak}}{{I}_{amb}} & ( 1 )\end{matrix}$$

$$\\ \begin{matrix}[ Math 2 ] & \\ SN = {I}_{peak} - {I}_{amb} & ( 2 )\end{matrix}$$

$$\\ \begin{matrix}[ Math 3 ] & \\ SN = \frac{{I}_{peak} - {I}_{amb}}{{I}_{max} - {I}_{amb}} & ( 3 )\end{matrix}$$

$$\\ \begin{matrix}[ Math 4 ] & \\ SN = \frac{{I}_{peak} - {I}_{amb}}{\sqrt{{I}_{amb} * ( 1 - \frac{{I}_{amb}}{{I}_{max}} )}} & ( 4 )\end{matrix}$$

As shown in FIG. 5, “Imax” of FIG. 5 is the maximum value that the light receiving element can take, “Ipeak” of FIG. 5 is the peak value of the response pulse, and “lamb” of FIG. 5 is the minimum value of the response pulse. For example, when the S/N ratio calculated by equation (1) is equal to or greater than a predetermined threshold value which is an appropriate reliability value, it is determined that the response pulse is an appropriate response pulse with less noise. In addition, the calculation methods of the S/N ratios of equations (1) to (4) may be used individually or may be determined by combining them.

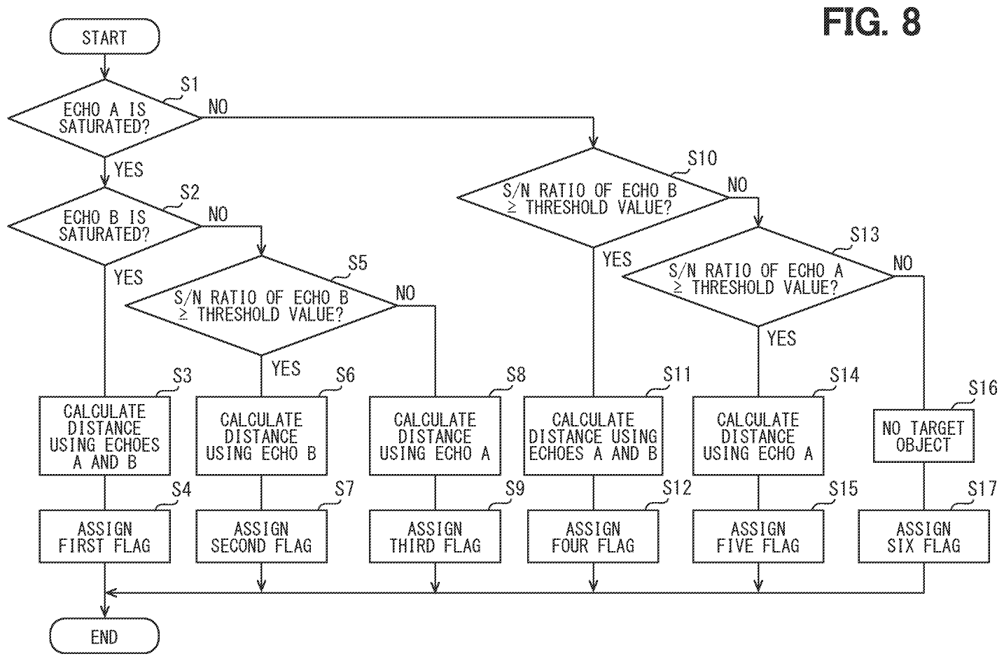

Next, specific processing of the distance calculator 26 will be described. A flowchart of FIG. 8 is a process of the distance measurement program repeatedly executed by the distance calculator 26 in a short time in a state where power of the distance measurement device 100 is turned on. In FIG. 8, the first response pulse 43 is referred to as an echo A, and the second response pulse 44 is referred to as an echo B.

In step S1, it is determined whether the echo A is saturated. When the echo A is saturated, the process proceeds to step S2, and when the echo A is not saturated, the process proceeds to step S10. In step S2, it is determined whether the echo B is saturated. When the echo B is saturated, the process proceeds to step S3, and when the echo B is not saturated, the process proceeds to step S5. The saturation determination method described above is used to determine the saturation.

In step S3, since both the echo A and the echo B are saturated, the distance is calculated using the echo A and the echo B, and the process proceeds to step S4. Since both response pulses are saturated, the distance is calculated for each response pulse, and the distance is calculated by averaging or the like. In step S4, a first flag is assigned, and the process terminates. A flag, for example the first flag, will be described later.

In step S5, it is determined whether the S/N ratio of the echo B is equal to or greater than a threshold value. When the S/N ratio is equal to or greater than the threshold value, the process proceeds to step S6, and when the S/N ratio is not equal to or greater than the threshold value, the process proceeds to step S8. In step S8, since the echo B is not saturated and the reliability in the S/N ratio is high, the distance is calculated using the echo B, and the process proceeds to step S7. In step S7, a second flag is assigned, and the process terminates.

In step S8, although the echo B is not saturated, since the reliability in the S/N ratio is low, the distance is calculated using the saturated echo A, and the process proceeds to step S9. In step S9, a third flag is assigned, and the process terminates.

In step S10, since the echo A is not saturated, it is determined whether the S/N ratio of the echo B is equal to or greater than a threshold value. When the S/N ratio is equal to or greater than the threshold value, the process proceeds to step S11, and when the S/N ratio is not equal to or greater than the threshold value, the process proceeds to step S13. In step S11, since the echo A and the echo B are not saturated and the reliability of the S/N ratio of the echo B is high, the distance is calculated using the echo A and the echo B, and the process proceeds to step S12. Since the emission intensity of the first emission pulse 41 is higher, when the echo A based on the first emission pulse 41 is not saturated, it is estimated that the echo B based on the second emission pulse 42 is not saturated. In step S12, a fourth flag is assigned, and the process terminates.

In step S13, since the echo A is not saturated but the S/N ratio of the echo B is not equal to or greater than the threshold value, it is determined whether the S/N ratio of the echo A is equal to or greater than the threshold value. When the S/N ratio is equal to or greater than the threshold value, the process proceeds to step S14, and when the S/N ratio is not equal to or greater than the threshold value, the process proceeds to step S16. In step S14, although the echo A and the echo B are not saturated, since the reliability of the S/N ratio of the echo B is low and the reliability of the S/N ratio of the echo A is high, the distance is calculated using only the echo A, and the process proceeds to step S15. In step S15, a fifth flag is assigned, and the process terminates.

In step S16, although the echo A and the echo B are not saturated, since the reliability of the S/N ratios of the echo A and the echo B is low, it is determined that there is no target object 101, and the process proceeds to step S17. In step S17, a sixth flag is assigned, and the process terminates.

In this way, distance calculation patterns are divided into six distance calculation patterns according to the presence or absence of saturation of the echo A and the echo B and the presence or absence of reliability of the echo A and the echo B by the S/N ratio. Different flags are assigned to the respective patterns.

The first flag to the sixth flag are response pulse information related to the echo A and the echo B. The response pulse information includes information such as the detection timing, the received light intensity, and the S/N ratio of each echo. In the present embodiment, the response pulse information is indicated by six flags. The first flag to the sixth flag are given as rough classification information of the reflection intensity from the target object 101 to be used in a subsequent processing. The reflection intensity decreases in the order from the first flag to the sixth flag. For example, in the first flag, since the echo A and the echo B are saturated, the reflection intensity is the strongest, and there is a high possibility that the target object 101 is a high-luminance object. Therefore, the distance is calculated using the saturated echo A and the saturated echo B.

As shown in FIG. 8, the distance calculator 26 calculates the distance using the detection timing of the response pulse having a peak value less than the detection upper limit of the light receiving unit 12 among the response pulses included in the detection information. A response pulse having a peak value less than the detection upper limit is synonymous with a response pulse that is not saturated. More specifically, as shown in step S6, step S11, and step S14 of FIG. 8, when the echo A and the echo B are not saturated, the distance is calculated using a response pulse that is not saturated. This is to improve the measurement accuracy of the distance.

As shown in FIG. 8, the distance calculator 26 calculates the distance using the detection timing of a response pulse having a peak value less than the detection upper limit of the light receiving unit 12 and having a signal-to-noise ratio greater than a predetermined reliability value among the response pulses included in the detection information. More specifically, as shown in step S6, step S11, and step S14 of FIG. 8, the distance is calculated when the S/N ratio is equal to or greater than the threshold value. This is because the distance measurement accuracy is improved by using a response pulse with less noise.

Further, as shown in FIG. 8, when there is no response pulse having a peak value less than the detection upper limit of the light receiving unit 12 among the response pulses included in the detection information, the distance calculator 26 calculates the distance using the detection timings of all the response pulses included in the detection information. More specifically, as shown in step S3 of FIG. 8, since the echo A and the echo B are saturated, the distance is calculated using the echo A and the echo B. Although the detection accuracy decreases in the saturated echo, the decrease in the detection accuracy can be reduced by using two echoes.

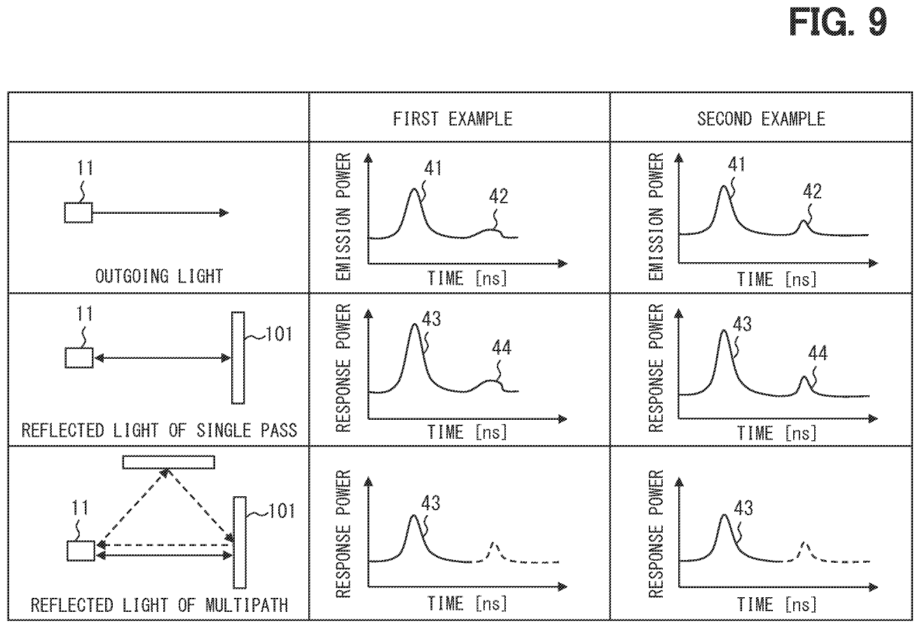

Next, a shape of the response pulse will be described. As shown in FIG. 9, in the outgoing light of the first example, the shapes of the first emission pulse 41 and the second emission pulse 42 are different from each other, and in the outgoing light of the second example, a shapes of the first emission pulse 41 and the second emission pulse 42 are similar to each other. In other words, the light emission controller 23 controls the light emitting unit 11 to emit light pulses respectively having different light emission intensities per unit measurement time and having the same waveform shape. The same waveform shape includes a similar shape.

In the first example and the second example, in a case of a single pass, the reflected light has the same shape as the outgoing light. Contrary to this, in a case of multipath, as shown in FIG. 9, the reflected light and the outgoing light are different in the first example. More specifically, the waveform comparator 27 of the signal processing device 20 compares response pulses included in the detection information and light pulses emitted by the light emitting unit 11 with respect to waveform shapes in chronological order. Then, the waveform comparator 27 determines the presence or absence of the multipath. In the first example, in the case of the multipath, the waveform shapes of the first emission pulse 41 and the first response pulse 43 are the same, and the waveform shapes of the second emission pulse 42 and the second response pulse 44 are different. In the second example, in the case of the multipath, the waveform shapes of the first emission pulse 41 and the first response pulse 43 are the same, and the waveform shapes of the second emission pulse 42 and the second response pulse 44 are also the same.

Therefore, the waveform comparator 27 can determine whether the output light is the multipath based on the outgoing light of the first example. This is because, in the case of the multipath, a reflected light of a detour path indicated by a dashed line has a long path length, and thus reaches the light receiving unit 12 later, and the first response pulse 43 of the detour path indicated by the dashed line may arrive earlier than the second response pulse 44 of the straight path indicated by a solid line.

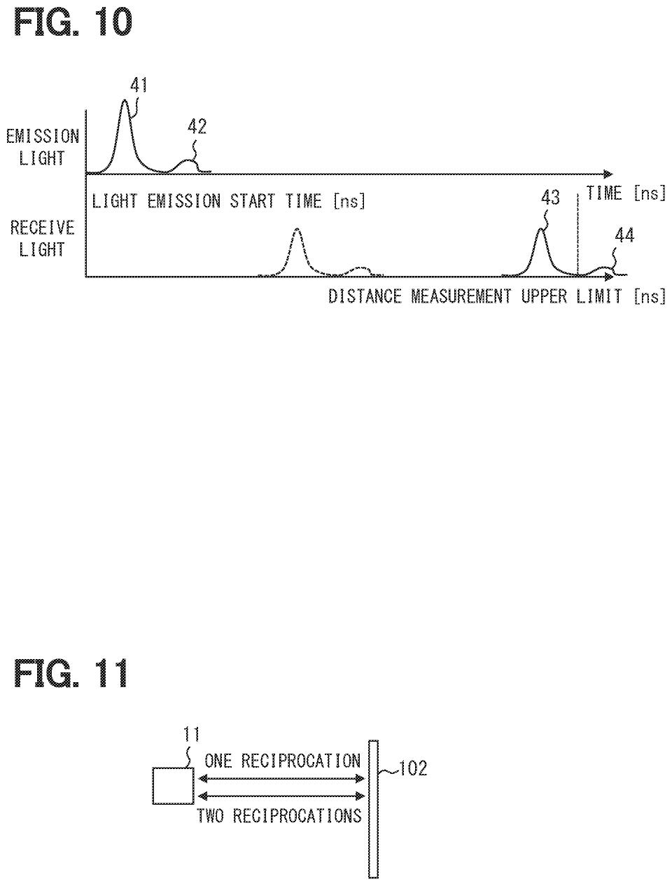

Next, the light emission intensity will be described. The light emission intensity is also referred to as light emission power. As shown in FIG. 3, the first emission pulse 41 has a higher emission intensity than the second emission pulse 42. Accordingly, as shown in FIG. 10, it is possible to maintain the same measuring range as that of a comparative example in which only the first emission pulse 41 is used.

More specifically, as shown in FIG. 10, since the number of sampling times from the light emission start time to a distance measurement upper limit is determined and the second emission pulse 42 is emitted later than the first emission pulse 41, the distance range including the second emission pulse 42 is reduced by a delay as compared to a comparative example in which only the first emission pulse 41 is used. However, when only the first emission pulse 41 is viewed, the measuring range is the same as that of the comparative example. Further, since the second emission pulse 42 is returned at a short distance in many cases, the distance can be measured with higher accuracy using the second emission pulse 42.

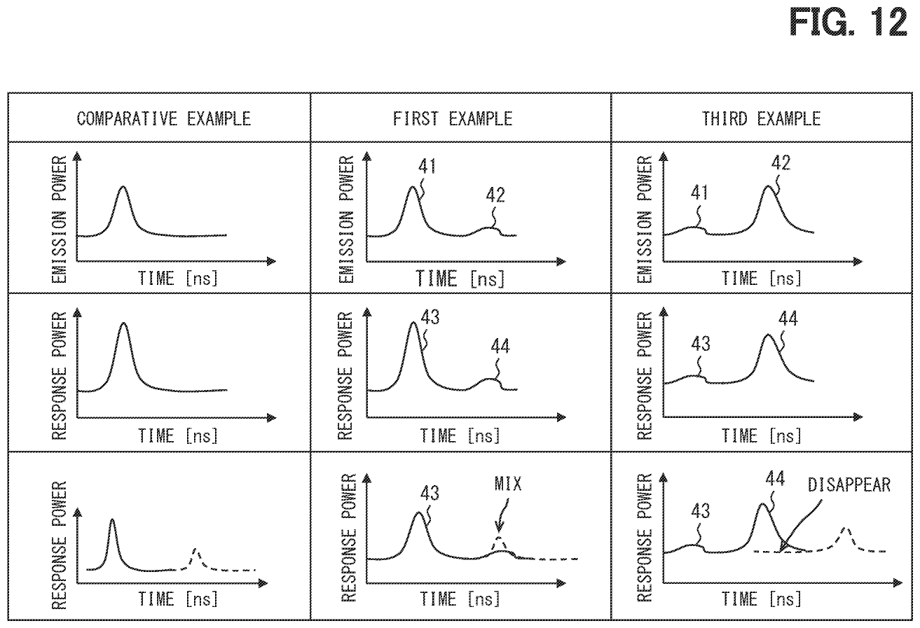

In an example shown in FIG. 3, the first emission pulse 41 has a higher emission intensity than the second emission pulse 42, but the present invention is not limited to such an intensity relationship. In contrast to the first example, the emission intensity of the second emission pulse 42 may be higher than that of the first emission pulse 41. For example, as shown in FIG. 12 as a third example, a first emission pulse 41 has a smaller emission intensity than a second emission pulse 42, and waveform shapes thereof are different from each other.

In the third example, an influence of multiple reflection by an internal reflection object and a high luminance reflection object 102 can be reduced. The high luminance reflection object 102 is a target object 101 having a high luminance surface. More specifically, as shown in FIG. 11, in the multiple reflection by the internal reflection object and the high luminance reflection object 102, there is a case where the outgoing light is not reciprocated by one reciprocation, but reciprocated by two reciprocations by the internal reflection object and the high luminance reflection object 102, and is incident on the light receiving unit 12. Therefore, the multiple reflection by the high luminance reflection object 102 is a phenomenon in which a pseudo echo is seen when the emission intensity is high.

Therefore, as in the third example, by emitting the weak first emission pulse 41 first, the influence can be reduced. More specifically, as shown in FIG. 12, in a case of the multiple reflection, the second response pulse 44 becomes a pseudo echo in a comparative example. In the first example, the pseudo echo and the second response pulse 44 of the reflected light may or may not be mixed depending on the sampling time, and it cannot be determined whether the detected second response pulse 44 is the pseudo echo or the second response pulse 44 of the reflected light. This is because the emission intensity of the pseudo echo is weak and the emission intensity of the second emission pulse 42 of the first example is small.

Contrary to this, in the third example, since the emission intensity of the second emission pulse 42 is large, the first response pulse 43 of the pseudo echo and the second response pulse 44 of the reflected light can be distinguished from each other. In other words, when the first response pulse 43 of the pseudo echo and the second response pulse 44 of the reflected light are mixed, the intensity of the second response pulse 44 of the reflected light is large, and thus the pseudo echo appears to disappear. Therefore, in the third example, the influence of the pseudo echo can be reduced.

Next, the light emission period will be described. As shown in FIG. 3, the outgoing light has an interval of a predetermined time T3 provided between the first emission pulse 41 and the second emission pulse 42. The predetermined time T3 is set to a time during which the light receiving unit 12 can separately process the first emission pulse 41 and the second emission pulse 42. When the predetermined time T3 is too short, the first response pulse 43 and the second response pulse 44 cannot be separated from each other, and when the predetermined time T3 is too long, a measurement cycle of distance measurement decreases. The predetermined time T3 may preferably equal to or greater than a width of the waveform obtained by, for example convolution of a response function of the SPAD and a transfer function of the light emission waveform. The response function of the SPAD depends on a dead time.

Next, the wavelength of the outgoing light will be described. The first emission pulse 41 and the second emission pulse 42 of the outgoing light may have the same wavelength or different wavelengths. When the first emission pulse 41 and the second emission pulse 42 have the same wavelength, the same device can be used, and a circuit becomes simple. A case where the wavelengths are the same includes a case where the wavelengths are not completely the same and at least a part of the wavelength bands overlap.

Further, when the first emission pulse 41 and the second emission pulse 42 have different wavelengths, sensitivity can be adjusted by transmittance in addition to the light emission intensity by using a different bandpass filter for each wavelength in the light receiving unit 12. The different wavelengths include a case where the wavelength bands do not have an overlapping portion and are different from each other, a case where the wavelength bands partially overlap but peak wavelengths are different from each other, and a case where the wavelength bands partially overlap but half or more of the wavelength bands are different from each other. This facilitates an expansion of a dynamic range. More specifically, when the wavelengths of the first emission pulse 41 and the second emission pulse 42 are the same, the reflected light of the first emission pulse 41 and the reflected light of the second emission pulse 42 pass through the same band-pass filter, and thus the transmittance of the band-pass filter is also the same. Contrary to this, when the wavelengths of the first emission pulse 41 and the second emission pulse 42 are different from each other, the first emission pulse and the second emission pulse are passed through different bandpass filters. Therefore, by making the transmittance of the band-pass filter different, the transmittance of the reflected light of the first emission pulse 41 and the transmittance of the reflected light of the second emission pulse 42 can be adjusted separately. This makes it easier to detect the first response pulse 43 and the second response pulse 44.

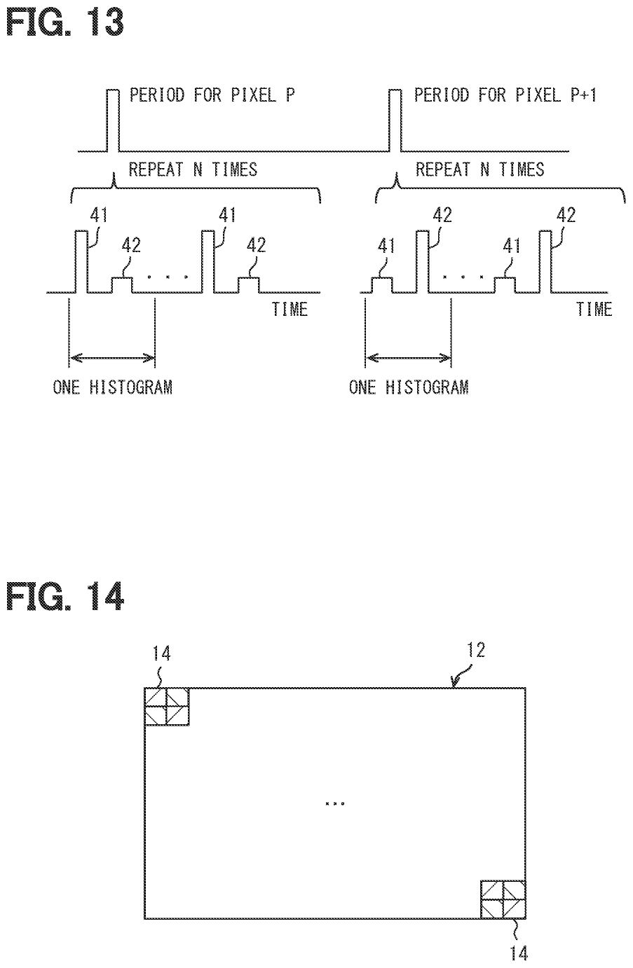

Next, the light emission sequence will be described. As described with reference to FIG. 4, the outgoing light may be emitted in the same light emission pattern for each pixel 14, or as shown in FIGS. 13 and 14, the emission light may be emitted in different light emission patterns for each pixel 14. In other words, the light emission controller 23 may control the light emitting unit 11 to emit light in a different light emission pattern for each divided region obtained by dividing the target region into a plurality of regions. One divided region corresponds to one pixel 14. Since a combination of all the divided regions becomes a target region, a point group image of the target region can be formed by all pixels 14. In FIGS. 14 to 17, the same light emission patterns are indicated by the same hatching for easy understanding.

For example, as shown in FIG. 13, the light emission patterns are controlled to be different between a period for a certain first pixel p and a period for another second pixel p+1. For example, in the period for the first pixel p, the light emission pattern using the outgoing light of the first example is used, and in the period for the second pixel p+1, the light emission pattern using the outgoing light of the third example is used.

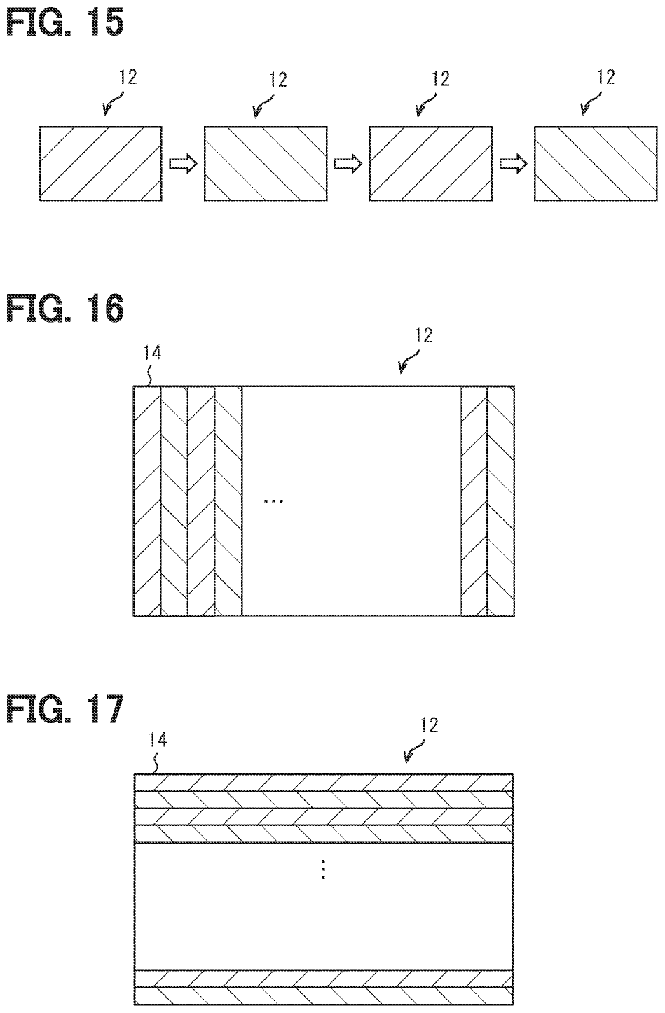

Similarly, as shown in FIG. 15, the light emission pattern may be different between frames. Two types of light emission patterns may be alternately switched so that the light emission patterns are different in adjacent frames.

In addition, as shown in FIG. 16, the light emission pattern may be controlled such that the light emission patterns in the pixels 14 adjacent in a left-right direction are different and the light emission patterns in the pixels 14 adjacent in an up-down direction are the same. As shown in FIG. 17, the light emission patterns may be controlled so that the light emission patterns in the pixels 14 adjacent to each other in the left-right direction are the same and the light emission patterns in the pixels 14 adjacent to each other in the up-down direction are different.

By controlling light emission in units of pixels 14 or frames using different light emission patterns in this manner, the dynamic range can be expanded without a decrease in FPS. In addition, by using a light emission pattern with low power consumption compared to a case with the same light emission pattern, the overall power consumption can be reduced.

As described above, according to the distance measurement device 100 and the distance measurement method of the present embodiment, since the light pulse has different light emission intensities per unit measurement time, the response pulses can be obtained by the light receiving unit 12 when there is reflection from the target object 101. Therefore, the distance can be calculated using the detection timings of the response pulses included in the detection information. For example, even when the detection timing of one response pulse is unclear due to saturation, noise, or the like, if the detection timing of another response pulse is clear, the distance can be measured using another response pulse. Accordingly, the distance measurement device 100 and the distance measurement method with excellent measurement accuracy can be realized.

In addition, in the present embodiment, the distance calculator 26 calculates the distance using the detection timing of the response pulse having a peak value less than the detection upper limit of the light receiving unit 12 among the response pulses included in the detection information. Since the distance is calculated by the response pulse having the peak value, the distance can be calculated with high accuracy.

Further, in the present embodiment, the distance calculator 26 calculates the distance using the detection timing of a response pulse having a peak value less than the detection upper limit of the light receiving unit 12 and having a signal-to-noise ratio equal to or greater than a predetermined reliability value among the response pulses included in the detection information. Therefore, since the response pulse with the peak value and the S/N ratio higher than the reliability value and high reliability is used, the distance can be calculated with high accuracy.

In the present embodiment, when there is no response pulse having a peak value less than the detection upper limit of the light receiving unit 12 among the response pulses included in the detection information, the distance calculator 26 calculates the distance using the detection timings of all the response pulses included in the detection information. In a case where all the response pulses are saturated, the accuracy is reduced by one response pulse, but the reduction in accuracy can be reduced by using a plurality of response pulses.

Further, in the present embodiment, the waveform comparator 27 compares response pulses included in the detection information with waveform shapes irradiated by the light emitting unit 11 in chronological order. The waveform comparator 27 is capable of determining the presence or absence of multipath by comparing waveform shapes. As a result, the distance can be calculated by excluding the detection information of the multipath, and the influence of the multipath can be reduced.

In the present embodiment, the distance measurement method includes controlling the light emitting unit 11 to emit light pulses respectively having different light emission intensities toward the target region per unit measurement time, acquiring detection information obtained by the light receiving unit 12 that detects light from the target region, and calculating the distance to the target object 101 using detection timings of response pulses generated by the light pulses included in the detection information being reflected by the target object 101. As a result, the distance can be calculated with high accuracy as described above.

### Other Embodiments

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the above-described first embodiment, the number of light pulses of the outgoing light is two, that is, large and small. However, the number of light pulses is not limited to two, and may be three or more. In addition, the light receiving unit 12 has the SPAD, but is not limited to the SPAD, and may be another image sensor such as a CMOS sensor.

In the above-described first embodiment, the functions realized by the signal processing device 20 may be realized by hardware and software different from those described above or by a combination of the hardware and the software. The signal processing device 20 may communicate with, for example, another control device, and the other control device may execute a part or all of the process. When the signal processing device 20 is realized by an electronic circuit, the signal processing device 20 may be realized by a digital circuit or an analog circuit, including a large number of logic circuits. More specifically, the signal processing device 20 may be a locator ECU that estimates a self-position of the vehicle. The signal processing device 20 may be an ECU that controls an advanced driving assistance or an automated driving of a vehicle. The signal processing device 20 may be an ECU that controls a communication between a vehicle and an outside.

The signal processing device 20 may further include a field-programmable gate array (i.e., FPGA), a neural network processing unit (i.e., NPU), an IP core having other dedicated functions, and the like. The signal processing device 20 may be individually mounted on a printed circuit board, or may be mounted on an ASIC (Application Specific Integrated Circuit), a FPGA, or the like.

Whereas the distance measurement device 100 is used in a vehicle in the first embodiment mentioned before, the distance measurement device 100 may be used not only in a state that it is mounted on a vehicle, but also in a state that the distance measurement device 100 is not mounted on a vehicle at least partially.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A distance measurement device for irradiating a target region with light and measuring a distance to a target object present in the target region, comprising:
a light emission controller configured to control a light emitting unit configured to emit light toward the target region;
a detection information acquirer configured to acquire detection information obtained by a light receiving unit configured to detect light from the target region; and
a distance calculator configured to calculate a distance to the target object using the detection information, wherein
the light emission controller is configured to control the light emitting unit to emit light pulses respectively having different light emission intensities for different light emission periods per unit measurement time, and
the distance calculator is configured to calculate the distance using detection timings of response pulses respectively generated by the light pulses being reflected from the target object.

2. The distance measurement device according to claim 1, further comprising
a waveform comparator configured to
arrange the response pulses included in the detection information in chronological order,
arrange the light pulses emitted by the light emitting unit in chronological order, and
compare a waveform shape of the response pulse and a waveform shape of the light pulse in chronological order, wherein
the light emission controller is configured to control the light emitting unit to emit the light pulses respectively having different light emission intensities and respectively having different waveform shapes for different light emission periods per unit measurement time, and
the distance calculator is configured to calculate the distance using a detection timing of the response pulse determined to be a single path instead of a multipath as a result of comparison by the waveform comparator.

3. The distance measurement device according to claim 1, wherein
the distance calculator is configured to calculate the distance using a detection timing of the response pulse having a peak value less than a detection upper limit of the light receiving unit among the response pulses included in the detection information.

4. The distance measurement device according to claim 1, wherein
the distance calculator is configured to calculate the distance using a detection timing of the response pulse having a peak value less than a detection upper limit of the light receiving unit and having a signal to noise ratio equal to or greater than a predetermined reliability value among the response pulses included in the detection information.

5. The distance measurement device according to claim 3, wherein
the distance calculator is configured to calculate the distance using detection timings of all of the response pulses included in the detection information when there is no response pulse having a peak value smaller than the detection upper limit of the light receiving unit among the response pulses included in the detection information.

6. The distance measurement device according to claim 1, wherein
the light emission controller is configured to control the light emitting unit to emit light pulses having different light emission intensities and a same waveform shape per unit measurement time.

7. The distance measurement device according to claim 1, wherein
the light emission controller is configured to control the light emitting unit to emit, per the unit measurement time, a first light pulse in a first part and a second light pulse in a second part later than the first part,
a light emission intensity of the first light pulse is greater than a light emission intensity of the second light pulse.

8. The distance measurement device according to claim 1, wherein
the light emission controller is configured to control the light emitting unit to emit, per the unit measurement time, a first light pulse in a first part and a second light pulse in a second part later than the first part,
a light emission intensity of the second light pulse is greater than a light emission intensity of the first light pulse.

9. The distance measurement device according to claim 1, wherein
the light emission controller is configured to control the light emitting unit to emit two light pulses having different light emission wavelengths per unit measurement time.

10. The distance measurement device according to claim 1, wherein
the light emission controller is configured to control the light emitting unit to emit two light pulses having a same light emission wavelengths per unit measurement time.

11. The distance measurement device according to claim 1, wherein
the light emission controller is configured to control the light emitting unit to emit light in a different light emission pattern for each divided region obtained by dividing the target region into regions, and
the light emission pattern is a combination of a number of the light pulses per unit measurement time, a light emission intensity of the light pulse, and a waveform shape of the light pulse.

12. The distance measurement device according to claim 1, wherein
the light emission controller is configured to control the light emitting unit to emit light in a different light emission pattern for each frame, and
the light emission pattern is a combination of a number of the light pulses per unit measurement time, a light emission intensity of the light pulse, and a waveform shape of the light pulse.

13. The distance measurement device according to claim 1, wherein
the distance calculator is configured to output response pulse information regarding response pulses included in the detection information.

14. A distance measurement method for measuring a distance to a target object in a target region, and executed by at least one processor, the method comprising:
controlling the light emitting unit to emit light toward the target region with light pulses respectively having different light emission intensities for different light emission periods per unit measurement time;
acquiring detection information obtained by a light receiving unit configured to detect light from the target region; and
calculating the distance using detection timings of response pulses included in the detection information and respectively generated by the light pulses being reflected from the target object.

15. A distance measurement device comprising:
at least one processor configured to
control a light emitting unit to emit, toward a target region, light pulses respectively having different light emission intensities for different light emission periods per unit measurement time for different light emission periods;
acquire, using a light receiving unit configured to detect light from the target region, detection timings of response pulses respectively generated by the light pulses being reflected from the target object; and
calculate a distance to a target object present in the target region using the detection timings.
